(19) United States
(12) Patent Application Publication
(10) Pub. No.: US 2009/0245748 A1
(43) Pub. Date: Oct. 1, 2009

(54) Method and Apparatus for Recording and Reproducing Image

(75) Inventor: Koji Miyazaki, Hamura-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/404,207

(22) Filed: Mar. 13, 2009

(30) Foreign Application Priority Data
Mar. 31, 2008 (JP) 2008-094373

(51) Int. Cl. H04N 5/91

(52) U.S. Cl. 386/46

(57) ABSTRACT

According to one embodiment of the invention, it is possible to provide an instruction unit which instructs movement or replication of contents held by the recording unit, to/in an external recording apparatus provided independently of the recording unit, or a removable recording medium, a power supply state detection unit which detects a state of a power supply, and it is possible to execute an operation of moving or replicating the contents held by the recording unit, to/in the external recording apparatus or a removable recording medium, after a change in the state of a power supply is detected by the power supply state detection unit.

### CROSS-REFERENCE TO RELATED APPLICATIONS

This application is based upon and claims the benefit of priority from Japanese Patent Application No. 2008-094373, filed Mar. 31, 2008, the entire contents of which are incorporated herein by reference.

### BACKGROUND

1. Field

The present invention relates to a recording/reproducing apparatus and method, which can move or replicate images and sounds recorded by a recording unit, or recorded programs in a television receiver having a large-capacity recording medium, to/in another recording apparatus or another television receiver having a recording unit.

2. Description of the Related Art

A video reproducing apparatus such as a television receiver (hereinafter, called simply a TV set) has been widely used, which receives and reproduces digital broadcast images and sounds, or television broadcast programs. A TV set provided with a recording unit as one body has become popular.

However, the capacity of a recording unit is limited, and it is necessary to secure the recording capacity for a recording unit provided in a TV set as one body by moving data of recorded programs or contents to an external recording apparatus.

Japanese Patent Application Publication (KOKAI) No. 2008-21349 discloses a method of dimming or turning off display of a display unit, and stopping output of images and sounds to an external unit, when a reserved program recording start time comes up. Namely, if recording of a reserved program is started in a standby state in which a user probably not present near the recording/reproducing apparatus, it is prevented that images and sounds are suddenly output from an external apparatus.

In the user's manual (user's guide)—Operation Part—for Digital High-Definition Television Recorder DV-ARW 22 (pages 142 to 144) describes that a dubbing start time can be Previously selected for dubbing in the time when an apparatus is not operated.

The user's manual indicates that when dubbing a program from a hard disc drive (HDD) to a DVD disc and vice versa, a dubbing start time can be previously selected. However, in a recorder described in the above manual, a user is requested to perform troublesome operations, such as inputting a dubbing start time, after confirming time periods with no programs reserved for recording.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of a block diagram of a video recording/reproducing apparatus according to an embodiment of the invention;

FIG. 2 is an exemplary screen display showing a screen of “Recording List” displayed in a television receiver, according to an embodiment of the invention;

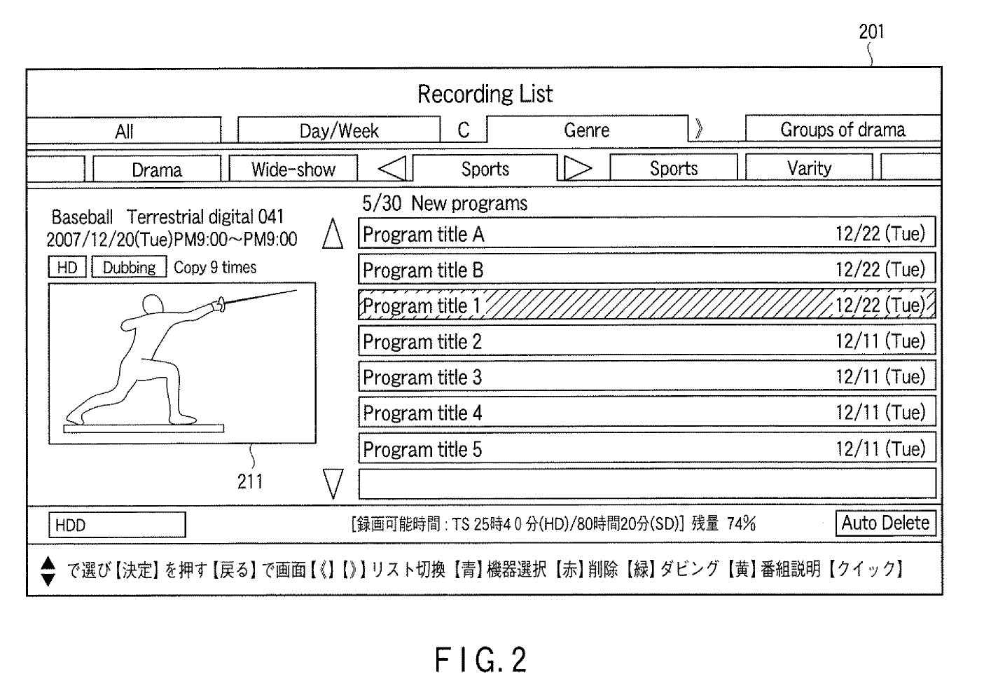

FIG. 3 is an exemplary diagram showing a dubbing (or a moving) destination specify screen displayed with the “Recording List,” screen in a television receiver, according to an embodiment of the invention;

FIG. 4 is an exemplary screen display showing a dialog screen for specifying a dubbing (or a moving) destination displayed with the “Recording List” screen in a television receiver, according to an embodiment of the Invention;

FIG. 5 is an exemplary diagram showing a concept of dubbing to be started when “Execute on standby” is selected in FIG. 4, displayed in a television receiver, according to an embodiment of the invention;

FIG. 6 is an exemplary timing chart explaining a method of determining a dubbing start time to enable dubbing without affecting recording of a reserved program, when “Execute on standby” is selected in FIG. 4, according to an embodiment of the invention; and

FIG. 7 is an exemplary flowchart explaining a method of determining a time to start dubbing when “Execute on standby” is selected in FIG. 4, according to an embodiment of the invention.

### DETAILED DESCRIPTION

Various embodiments according to the invention will be described hereinafter with reference to the accompanying drawings. In general, according to one embodiment of the invention, a recording/reproducing apparatus comprising: a recording module configured to record contents; an instruction module configured to instruct movement or replication of contents held by the recording unit, to/in an external recording apparatus provided independently of the recording unit, or a removable recording medium; a power supply state detection module configured to detect a state of a power supply; and a control module configured to control to execute an operation of moving or replicating the contents held by the recording unit, to/in the external recording apparatus, or a removable recording medium, after a change in the state of a power supply is detected by the power supply state detection module.

Embodiments of this invention will be described in detail with reference to the drawings. The various modules of the systems described herein can be implemented as software applications, hardware and/or software modules, or components on one or more computers, such as servers. While the various modules are illustrated separately, they may share some or all of the same underlying logic or code.

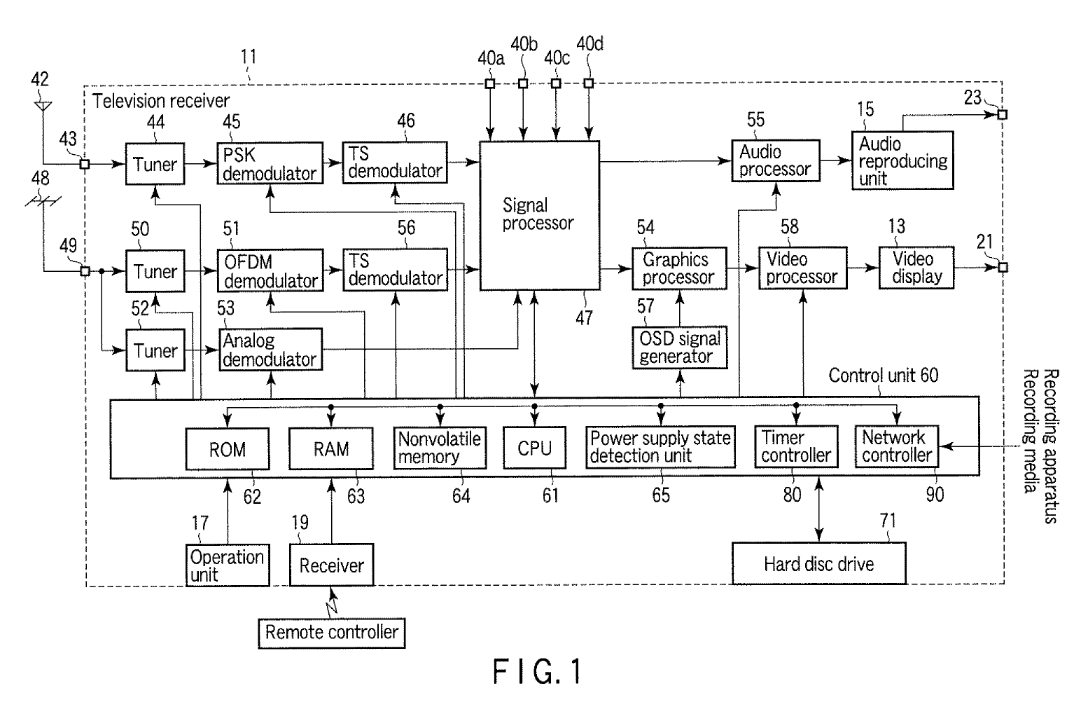

FIG. 1 shows an example of a television receiver to which an embodiment of the invention is applicable. in the television receiver explained hereinafter, a monitor unit may be a separate video recording apparatus (recorder) capable of outputting video signals, or a personal computer capable of recording video and audio data.

A television receiver 11 has a video display unit 13 which outputs video signals to be displayed on a display unit such as a liquid crystal panel, an audio reproducing unit 15 which outputs audio signals to be reproduced through an audio reproducing unit such as a speaker, an operation unit 17 which accepts a control input signal as a control instruction from a user, a remote control receiving unit 19 which accepts a control input signal given by a user as operation information through a remote controller, a hard disc drive (HDD) 71 which records a television program received through a tuner to be explained later, and a network controller 90 which can move or replicate a recorded program, video and audio data, to/in external hard disc drive or a television set provided with a hard disc drive.

The above television receiver 11 generally controls the operations, displays, or audio outputs of the above component units by using a control unit (may also be called a control block, or a main board) 60.

The control unit 60 includes a main control IC (LSI) such as a central processing unit module (CPU) 61, and controls each component by reflecting the operation information (input) from the control unit 17, or operation contents corresponding to a control signal (an input from the remote controller) sent from the remote controller and received by the remote control receiver 19.

The control unit 60 includes a read only memory module (ROM) 62 holding a control program to be executed by the CPU 61, for example, a random access memory module (RAM) 63 to provide a work area in the CPU 61, a nonvolatile memory module 64 to store various setting and control information, and a power supply state detection module 65 to detect the state of a power supply of a television receiver. The power supply detection module 65 detects whether or not the power of the video display unit 13, or a monitor unit, or a monitor panel is set to a power standby state in which the power of a monitor panel is changed from ON to OFF. That is, the control unit 60 detects a change in the power state of a television receiver, based on the power detection module 65.

The control unit 60 includes a timer controller module (a clock unit) 80 to count date and time, and can control the time, and reserve recording set by the user.

Hereinafter, an explanation will be given on a main signal processing system of the television receiver 11.

A satellite digital television broadcast signal received through an antenna 42 for receiving a BS/CS digital broadcast is supplied to a satellite digital broadcast tuner module 44 through an input terminal 43.

The tuner module 44 tunes a broadcast signal of a desired channel by a control signal from the control unit 60, and outputs the tuned broadcast signal to a phase shift keying (PSK) demodulator module 45.

The PSK demodulator module 45 demodulates the broadcast signal tuned by the tuner module 44, based on the control signal from the control unit 60, obtains a transport stream (TS) including a desired program, and outputs the transport stream to a TS demodulator module 46.

The TS demodulator module 46 performs TS demodulation of a transport stream multiplexed signal by the control signal from the control unit 60, outputs digital video and audio signals of a desired program to a signal processor module 47, and outputs various data, service information to obtain digital broadcast programs, electronic program guides (EPG), program attribute information showing program genre, etc., or subtitle information, to the control unit 60. This information is held in the RAM module 63 until a standby state is set by the user's setting or by the timer controller module 80.

A terrestrial digital television broadcast signal received through an antenna 48 for receiving a terrestrial broadcast is supplied to a terrestrial digital broadcast tuner module 50 through an input terminal 49.

The tuner module 50 tunes a broadcast signal of a desired channel by a control signal from the control unit 60, and outputs the tuned broadcast signal to an orthogonal frequency division multiplexing (OFDM) demodulator module 51.

The OFDM demodulator module 51 demodulates the broadcast signal tuned by the tuner module 50 by the control signal from the control unit 60, obtains a transport stream including a desired program, and outputs the transport stream to a TS demodulator module 56.

The TS demodulator module 56 performs TS demodulation of a TS multiplexed signal under the control of the control unit 60, outputs digital video and audio signals of a desired program to a signal processor module 47, and outputs various data to obtain digital broadcast programs, electronic program guides (EPG), and program attribute information showing program genre, etc., to the control unit 60. This information is held in the RAM module 63 until a standby state is set by the user's setting or by the timer controller module 80.

A terrestrial analog television broadcast signal received through the antenna 48 for receiving a terrestrial broadcast is supplied to a terrestrial analog broadcast tuner module 52 through the input terminal 49, thereby a broadcast signal of a desired channel is tuned. The broadcast signal tuned by the tuner module 52 is demodulated to analog video and audio signals by an analog demodulator module 53, and then output to the signal processor module 47.

The signal processor module 47 selectively performs predetermined digital signal processing for the digital video and audio signals supplied from the PSK demodulator module 45 and OFDM demodulator module 51, and outputs the processed signals to a graphics processor module 54 and an audio processor module 55.

The signal processor module 47 is connected to two or more (four in the drawing) input terminals 40a, 40b, 40c and 40d. These input terminals 40a to 40d permit external input of analog video and audio signals from the outside of the broadcast receiver 11.

The signal processor module 47 selectively digitizes the analog video and audio signals supplied from the analog demodulator module 53 and input terminals 40a to 40d, performs predetermined digital signal processing for the digitized video and audio signals, and outputs the processed signals to the graphics processor module 54 and audio processor module 55.

The graphics processor module 54 has a function to output an OSD signal generated by an on-screen display (OSD) signal generator module 57 by superposing it on the digital video signal supplied from the signal processor module 47. The graphics processor module 54 can selectively output the video signal output from the signal processor module 47 and the OSD signal output from the OSD signal generator module 57, and can output both signals by combining them so that each composes half a screen.

The OSD signal output from the OSD signal generator module 57 can also be output while superposed on an ordinary video display in a semitransparent state (to pass a part of an ordinary video signal), if a parameter for a blending is set.

When a broadcast signal includes a subtitle signal and a subtitle is displayable, the graphics processor module 54 superposes a subtitle on a video signal, based on the subtitle information and the control signal from the control unit 60.

The digital video signal output from the graphics processor module 54 is supplied to a video processor module 58. The video processor module 58 converts the digital video signal supplied from the graphics processor module 54, to an analog video signal to be reproducible as video (moving image/still image) output on a display unit (a monitor unit) connected to an output terminal 21 of the video display unit 13. The output terminal 21 may be omitted, and a monitor unit (a display unit) may be directly connected to the video display unit 13. The output terminal 21 may be connected to a DVD recorder using a DVD-standard optical disc as a recording medium, or a video recorder using a conventional videotape as a recording medium.

The audio processor module 55 converts the digital audio signal supplied from the signal processor, to an analog audio signal to be reproducible as a voice/audio output through a speaker or a headphone connected to the output terminal 23 of the audio reproducing unit 15. The output terminal 23 may be omitted, and a speaker may be directly connected to the audio reproducing unit 15.

The hard disc drive 71 is a storage including a magnetic disc, and is given a recording capacity of several 100 G bytes, for example, and can record television programs for a maximum of 1000 hours, depending on the recording rate.

The timer controller module (clock unit) 80 can hold reservation information, such as a recording start/end time, a recording channel and a recording rate for a program reserved by the user, for two or more programs. The timer controller module 80 can select a “dubbing during standby (execute on standby)” mode set by the user, for holding information about an operation time of the television receiver 11 and object program necessary for moving or replicating, or copying a recorded program or contents to another recording apparatus, a television set with a recording apparatus, or on a DVD-standard optical disc, and can sequentially check for a time overlap with an already reserved program.

The network controller module 90 is connected to a first hard disc (HDD 1) connected through a universal serial bus (USB) interface, or LANDISKS 1 to 4 configured to be connectable to a local area network (LAN), as another hard disc drive as an external unit. Therefore, when a desired hard disc is selected by the user through a remote control terminal, an optional recorded program recorded in the hard disc drive 71 is moved to or replicated on the selected hard disc.

If a recorded program or contents is protected against replication, a program held in the hard disc drive 71 is erased when the recording of the corresponding contents in an external unit is finished. If replication is instructed and the contents are replicated in an optional hard disc drive, the remaining recording capacity of the hard disc drive 71 is of course not increased. Erasure of the contents held in the hard disc drive 71 after moving the contents to another recording unit, another television set with a recording unit, or a DVD-standard optical disc, is substantially the same as moving the contents. Therefore, replicating or moving contents, and deleting contents remaining in a hard disc drive after replicating the contents are all called “dubbing” hereinafter.

Next, an explanation will be given on dubbing of a recorded program recorded by a recording unit of the television receiver shown in FIG. 1, to another recording apparatus.

When a “Recording list” is displayed by the user through the remote control terminal while receiving a TV program or reproducing contents, a “Recording list” screen 201 showing a list of recorded programs saved in a recording apparatus, or on the hard disc drive 71 appears, is displayed.

When a desired program is selected by the user through the remote controller by operating the cursor, a title image or a preset thumbnail image of the selected program is displayed in a sub-screen 211 defined at a predetermined position on the Recording list screen.

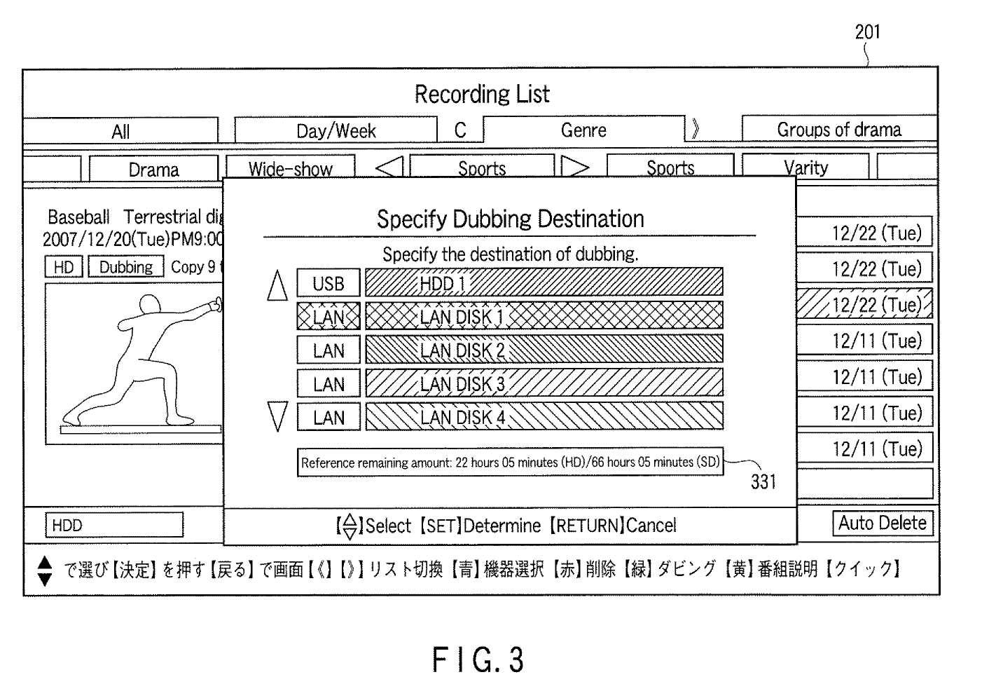

On the “Recording list” screen 201, two or more “Guidance” are displayed by the user through the remote control terminal, in which a corresponding control signal is input to the control unit 60 (refer to FIG. 1). Though not shown in the drawing, when a “green” key provided in the remote control terminal is operated, a “Dubbing destination” screen 321 for dubbing a selected program is displayed, as shown in FIG. 3.

When a “Red” key is operated through the remote control terminal, the display is shifted to a processing screen to delete a selected program, though this is not described in detail. When a “Set” key is operated, a selected program is displayed in full screen.

On the “Dubbing destination specify” screen 321 shown in FIG. 3, an external recording apparatus or another television receiver with a recording apparatus connected through the network controller module 90 shown in FIG. 1 is displayed.

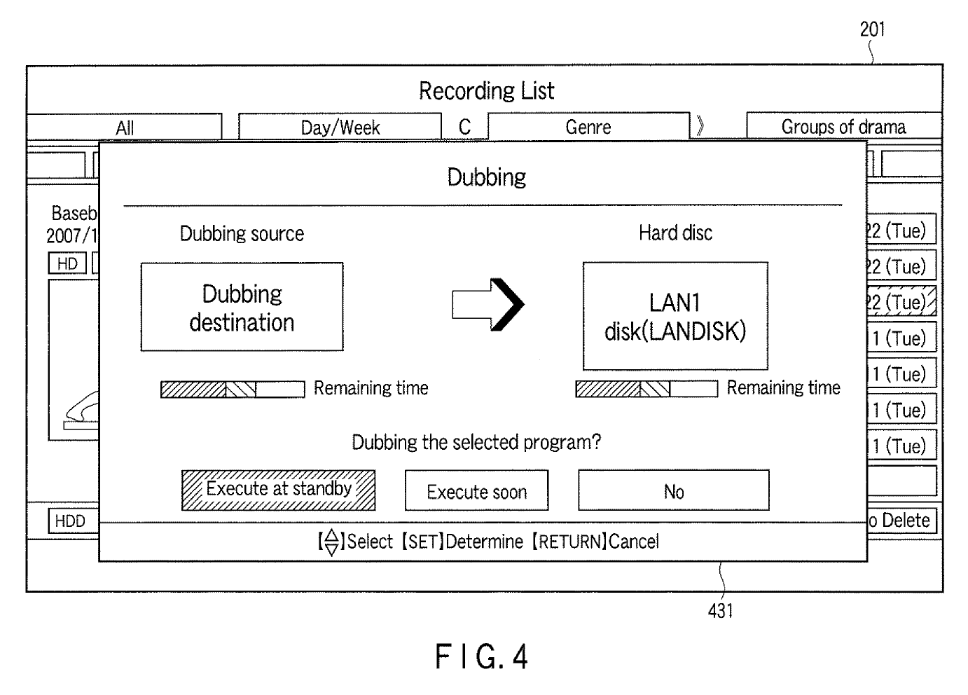

In this example, on the “Dubbing destination specify” screen 321, LANDISKs 1 to 4 connected through a LAN to the HDD 1 connected to a television receiver through USE are displayed as a choice. The state in which the LANDISK 1 is being selected by the user through the remote controller is notified to the user by reverse display or gray-down (the display color is changed to gray), for example. At this time, the free space of the LANDISK 1 that is a selected dubbing destination, is displayed in a “Display frame” 331 in the lower part of the “Recording list” screen 201. Of course, an object whose contents are recorded by dubbing may be an optical disc, such as a DVD-standard disc on which video and audio signals can be recorded. When the not-shown “Set” key of the remote control terminal is turned on by the user, a dialog screen to select a dubbing method as shown in FIG. 4 is displayed.

FIG. 4 is a dialog screen for a dubbing operation, and is used to select a dubbing method.

in a dubbing operation, the user can select one of “Execute on standby” and “Execute now” displayed on the dialog screen 431. When “Execute now” is selected, dubbing is immediately started except during recording a program. Therefore, some operations, such as recording a new program, are restricted until the dubbing is completed or the dubbing is stopped by the user.

When “Execute on standby” is selected, though the main power supply of a television set is on, a dubbing operation is started after shifting to a standby state in which the power supply of the video display unit 13 (refer to FIG. 1) is turned off (the power supply of a monitor unit or monitor panel is changed from ON to OFF).

Namely, even if dubbing is instructed for any one of recorded programs, dubbing is not immediately started. Dubbing is suspended until television receiver 11 is shifted to the power standby state in which the power of the video display unit 13, a monitor unit, or a monitor panel is changed from ON to OFF. The shift to the power standby state is executed by a power-off input by the user through the remote control terminal, or by actuating an auto-off (a sleep mode) previously set in the timer controller module 80.

More specifically, when “Execute on standby” is selected on the selection screen shown in FIG. 4, the user can view a television program or record a program tuned at that time without suffering restrictions by the dubbing operation, as long as the power supply of the monitor unit or a monitor panel of the television receiver is held ON.

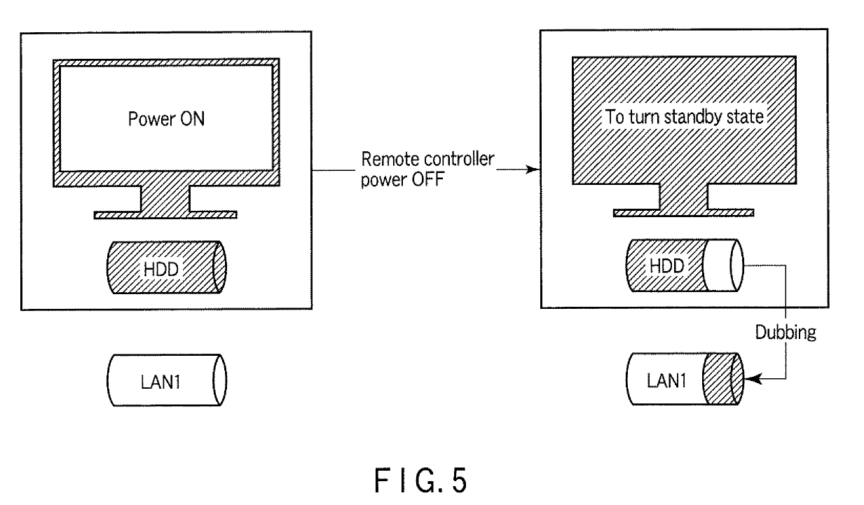

When the television receiver is shifted to the standby state (power standby state) by operating the not-shown power supply key of the remote controller, dubbing is started as shown in FIG. 5. Namely, the user does not actively operate the television receiver in the standby state, and the user does not feel any inconvenience caused by the dubbing, until the dubbing is completed or stopped by the user, even if some operations such as recording a new program are restricted.

If a program is reserved for recording even in the standby state (power standby sate), recording of a reserved program is started when the reserved program recording time comes up.

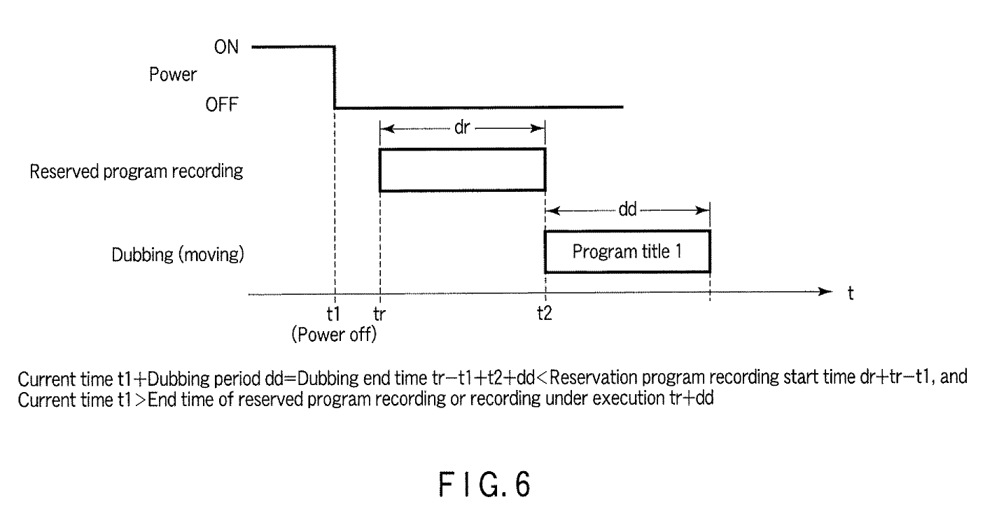

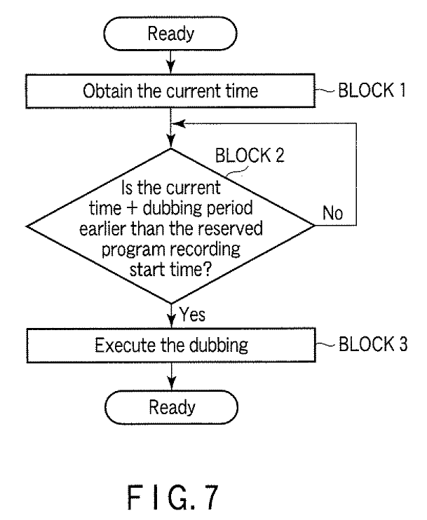

Therefore, when the television receiver is shifted to the standby state (power standby state), it is necessary that dubbing does not influence the recording of a reserved program. So, when “Execute on standby” is selected by the user, the timer controller module SO of the control unit 60 checks whether or not there is a program reserved for recording, which is to be recorded before the dubbing selected by “Execute on standby” is completed shown in FIGS. 6 and 7. If there is a reserved program, the timer controller module 80 of the control unit 60 checks whether there is time periods in which the dubbing selected by “Execute on standby” is executable.

Namely, as shown in FIG. 6, assuming that the time when the television receiver 11 is shifted to the standby state, that is,

when viewing or recording a desired program is completed, or when the display of image on the video display unit 13 is stopped, or when the power supply of a monitor unit as a video display unit, or a monitor panel is changed from ON to OFF, is t1;

the recording start time of an optional reserved program is t2;

the length of a program reserved for recording or a program under execution, or a program under recording is dr; and

the length of a program that is an object of dubbing is dd, respectively,

the dubbing start time to enable dubbing is obtained by the equations,

Current time t1+Dubbing period dd=

Dubbing end time tr−t1+t2+dd,

Dubbing end time tr−t1+t2+dd<Reserved program recording start time dr+tr−t1, and

Current time t1>End time of reserved program recording or recording under execution tr+dr.

The above operations are used for determination of whether or not the “Current time+dubbing time”, in which the dubbing time is added to the current time (block 1) obtained by the timer controller module 80 (refer to FIG. 1), is earlier than the recording start time of a reserved program recording or recording under execution (block 2).

Therefore, the dubbing selected by “Execute on standby” is executed when the television receiver 11 is shifted to the standby state at the time when the power supply of the video display unit 13 or a monitor unit or a monitor panel is changed from ON to OFF, that is, when the user stops viewing a program, or a reserved program recording is stopped during execution, and display of images on the video display unit 13 is stopped, if “Current time +Dubbing period” is earlier than the end time of reserved program recording or recording under execution. In the other cases, the selected dubbing is started after the dubbing enabled time period Is checked, and the dubbing is judged as possible (block 3).

The above function is also executable in a personal computer, by regarding the time when the power supply of a monitor unit is turned off (when a screen saver is actuated), or when the power supply of a monitor unit or a monitor panel is changed from ON to OFF, as the time of power-off, that is, the time when the television unit is shifted to the standby state. The function is executable also in a video recording apparatus not provided with a monitor unit, when the power supply is turned off by the user by operating a remote control terminal, that is, the standby state is set when the power is turned off.

As explained herein, by using one of the embodiments of the invention, it is possible to provide a recording/reproducing apparatus and method easy to use for the user, which can move or replicate new contents.

Namely, when movement or replication of contents is demanded, the apparatus can move or replicate contents during reproduction or recording of contents, or by extracting a time period in which a reserved program is not recorded.

Therefore, by setting movement or replication or contents, a TV program can be viewed or contents can be reproduced without restricting some operations such as recording a new program, until dubbing is completed or stopped by the user.

As for the dubbing mode, by providing an “Execute now” mode in which dubbing is immediately started except during recording a program, and an “Execute on standby” mode in which dubbing is started when the apparatus is shifted to the standby state, that is, when the power supply of the video display unit is turned off, or when the power supply of a monitor unit or monitor panel is changed from ON to OFF, the user is able to view a TV program or to record a program tuned at that time without suffering restrictions by the dubbing, as long as the power supply of a monitor unit or monitor panel of the television receiver is held ON.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A recording/reproducing apparatus comprising:
a recording module configured to record contents;
an instruction module configured to instruct movement or replication of contents held by the recording unit, to/In an external recording apparatus provided independently of the recording unit, or a removable recording medium;
a power supply state detection module configured to detect a state of a power supply; and
a control module configured to control to execute an operation of moving or replicating the contents held by the recording unit, to/in the external recording apparatus, or a removable recording medium, after a change in the state of a power supply is detected by the power supply state detection module.

2. The recording/reproducing apparatus of claim 1, wherein when the object file is detected by the file detection unit to control to execute the operation, after a change in the state of a power supply is detected by the power supply state detection module, the control unit does not display at least one of hierarchies higher than a hierarchy in which the object file exists, together with a list including the object file.

3. The recording/reproducing apparatus of claim 1, wherein the control unit determines whether or not there is a program reserved for recording, and if a reserved program recording exists, Judges whether or not the operation is completed before a start time of the reserved program recording, and starts the operation when the operation is judged completed before the reserved program recording start time.

4. The recording/reproducing apparatus of claim 1, wherein the control unit determines whether or not recording is now executed, and if recording is now executed, controls to execute the operation after the recording is finished.

5. The recording/reproducing apparatus of claim 1, further comprising:
a display unit to display reproduced images.

6. A recording/reproducing apparatus comprising:
an instruction module configured to instruct movement or replication of contents held by a contents recording unit, to/in an external recording apparatus provided independently of the recording unit, or a removable recording medium;
a power supply state detection module configured to detect a state of a power supply; and
a control module configured to control to execute an operation of moving or replicating the contents held by the recording unit, to/in the external recording apparatus, or a removable recording medium, after a power supply is judged as being in the standby state by the power supply state detection module.

7. A recording/reproducing method comprising:
instructing movement or replication of contents held by a contents recording unit, to/in an external recording apparatus provided independently of the recording unit, or a removable recording medium;
detecting a state of a power supply; and
controlling to execute an operation of moving or replicating the contents held by the recording unit, to/in the external recording apparatus, or a removable recording medium, after a change in the state of a power supply is detected.
